(19) United States
(12) Patent Application Publication
(10) Pub. No.: US 2023/0356136 A1
(43) Pub. Date: Nov. 9, 2023

(54) AIR-SOLUTION REGENERATION DEVICE

(71) Applicant: REPG ENERJI SISTEMLERI SANAYI VE TICARET ANONIM SIRKETI, Bursa (TR)

(72) Inventor: Hasan AYARTURK, Istanbul (TR)

(73) Assignee: REPG ENERJI SISTEMLERI SANAYI VE TICARET ANONIM SIRKETI, Bursa (TR)

(21) Appl. No.: 18/044,999

(22) PCT Filed: Aug. 13, 2021
(86) PCT No.: PCT/TR2021/050806

§ 371 Date: Mar. 13, 2023

(30) Foreign Application Priority Data
Sep. 15, 2020 (TR) 2020/14598

(51) Int. Cl. B01D 47/10; B01D 45/12; B01D 50/40; B03C 3/017; B03C 3/08; B03C 3/09; B03C 3/15; B03C 3/41; B03C 3/47

(52) U.S. Cl. CPC B01D 47/10; B01D 45/12; B01D 50/40; B03C 3/017; B03C 3/08; B03C 3/09; B03C 3/15; B03C 3/41; B03C 3/47

(57) ABSTRACT

An air-solution regeneration device is provided for providing equalization of the vapor pressure of a solution, which exists in a solution chamber, to the vapor pressure of the air which exists in the medium. Accordingly, the subject matter air-solution regeneration device comprises a solution pump for increasing the pressure of the solution which exists in said solution chamber; an air-solution injector which is in venturi type and which has a drive end which receives the solution, having increased pressure, as input, a suction end for realizing air suctioning when there is liquid input, having increased pressure, through the drive end, a spray end where the solution, received from said drive end, and the air, suctioned from said suction end, are sprayed; an electrostatic filter where the air-solution mixture is sprayed; and an air-solution separator which has a centrifuge unit for providing separation of the air-solution mixture, and an output chamber.

### CROSS REFERENCE TO THE RELATED APPLICATIONS

This application is the national phase entry of International Application No. PCT/TR2021/050806, filed on Aug. 13, 2021, which is based upon and claims priority to Turkish Patent Application No. 2020/14598, filed on Sep. 15, 2020, the entire contents of which are incorporated herein by reference.

### TECHNICAL FIELD

The present invention relates to air-solution regeneration for providing equalization of the vapor pressure of a solution which exists in a solution chamber to the vapor pressure of the air which exists in the medium.

### BACKGROUND

It may be desired that solutions have vapor pressure which is equal to the vapor pressure of the air which exists in the medium where said solutions exist, in order to be used for various purposes. When a solution stays in an open medium, said solution obtains vapor pressure, which is equal to the vapor pressure of the medium where said solution exists, by time. However, since this duration is long and since the vapor pressures between day/night and relative humidity are different, it becomes difficult to obtain vapor pressure so as to have the desired vapor pressure.

As a result, because of the abovementioned problems, an improvement is required in the related technical field.

### SUMMARY

The present invention relates to an air-solution regeneration device, for eliminating the abovementioned disadvantages and for bringing new advantages to the related technical field.

An object of the present invention is to provide an air-solution regeneration device for equalizing the vapor pressure of a solution to the vapor pressure of air, which exists in the medium, in an accelerated manner.

Another object of the present invention is to provide an air-solution regeneration device which provides cleaning of ambient air.

In order to realize the abovementioned objects and the objects which are to be deducted from the detailed description below, the present invention is an air-solution regeneration device for providing equalization of the vapor pressure of a solution, which exists in a solution chamber, to the vapor pressure of the air which exists in the medium. Accordingly, the improvement is that the subject matter air-solution regeneration device includes a solution pump for increasing the pressure of the solution which exists in said solution chamber; an air-solution injector which is in venturi type and which has a drive end which receives the solution, having increased pressure, as input, a suction end for realizing air suctioning when there is liquid input, having increased pressure, through the drive end, a spray end where the solution, received from said drive end, and the air, suctioned from said suction end, are sprayed; an electrostatic filter where the air-solution mixture is sprayed; and an air-solution separator which has a centrifuge unit for providing separation of the air-solution mixture, received from the input, from each other, and an output chamber for collecting the solution which is separated from air and which has been brought to equal vapor pressure as the air vapor pressure. Thus, by means of passing of the accelerated air-solution mixture through the electrostatic filter and by means of separating thereof in the separator, the vapor pressure of the solution, which exists in the output chamber of the mixer, is equalized to the air vapor pressure by means of a surprise effect.

In a possible embodiment of the present invention, said electrostatic filter includes a conductive first plate which allows liquid passage, a conductive second plate which allows liquid passage, and an ionizer provided between the first plate and the second plate for providing separation of the charged particles after the sprayed air-solution mixture passes through the first plate and for providing generation of electricity by forming voltage difference between the first plate and the second plate when the air-solution mixture, which has the charged particles which are separated, contacts the second plate. Thus, the electricity needed by the electrostatic filter and the pump is met from here, and energy consumption is reduced, or the operation of the system is provided automatically in case there is sufficient solution.

In another possible embodiment of the present invention, said air-solution separator includes an air output opening. Thus, the air, cleaned by separating the particles, is given back to the medium.

The structural and characteristic properties and all advantages of the present invention will be understood in a more clear manner by means of the below mentioned figures and the detailed description written by making reference to these figures, and therefore, evaluation shall be made by taking into consideration these figures and the detailed description.

### BRIEF DESCRIPTION OF THE DRAWINGS

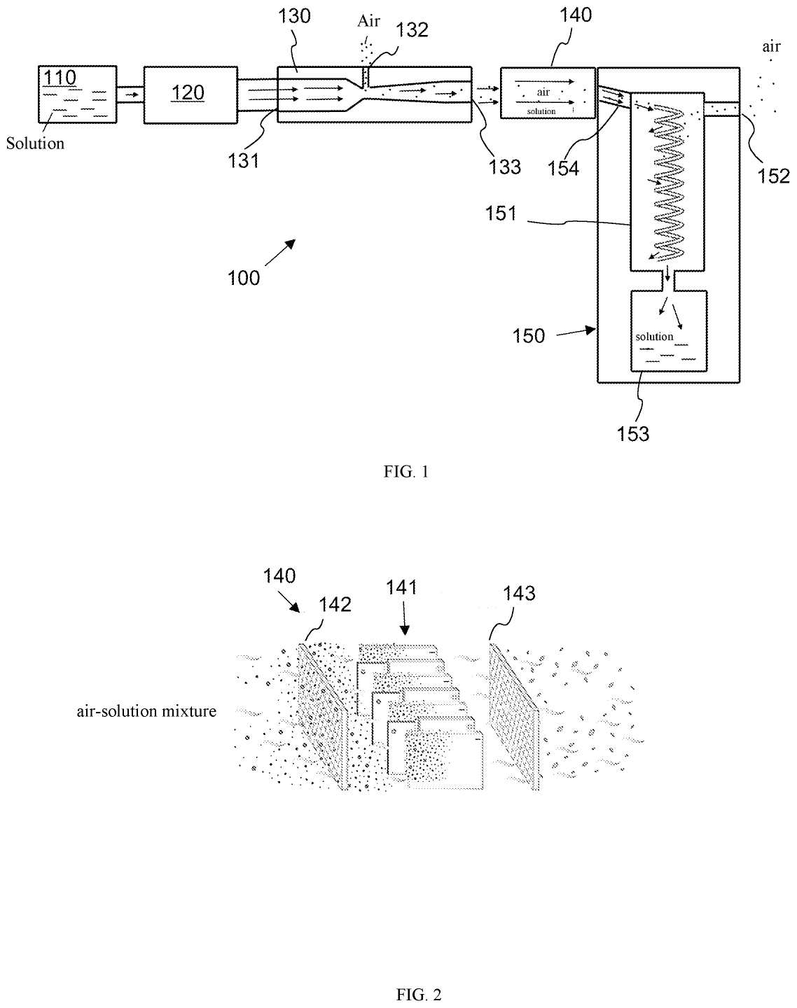

In FIG. 1, a representative view of the present invention is given.

In FIG. 2, a representative view of the electrostatic filter is given.

The drawings shall not be scaled and the details which are not necessary for understanding the present invention may be omitted. Besides, the elements, which are at least substantially identical or which has at least substantially identical functions, are shown with the same number.

### REFERENCE NUMBERS

100 Air-solution regeneration device
110 Solution pump
120 Solution chamber
130 Air-solution injector
   131 Drive end
   132 Suction end
   133 Spray end
140 Electrostatic filter
   141 Ionizer
   142 First plate
   143 Second plate
150 Air-solution separator
   151 Centrifuge unit
   152 Air output opening
   153 Output chamber
   154 Input

### DETAILED DESCRIPTION OF THE EMBODIMENTS

In this detailed description, the subject matter is explained with references to examples without forming any restrictive effect only in order to make the subject more understandable.

The present invention is an air-solution regeneration device (100) for providing equalization of the vapor pressure of a solution to the vapor pressure of the air, which exists in the medium, in an accelerated manner. The device moreover provides cleaning of the air which exists in the medium and purification from foreign substances at least partially. The present invention can be used in all fields related to air humidity balance and dehumidification and control systems, cooling systems with adsorption, electricity generation systems based on relative humidity.

The air-solution regeneration device (100) is associated with a solution chamber (120). Said solution chamber (120) keeps solution therein. Here, the mentioned solution describes a liquid and substance dissolved in said liquid. The solution can be sea water.

A solution pump (110) provides pressuring of the liquid which exists in the solution chamber (120). The solution pump (110) receives the solution as input (154) and provides giving of the solution in the form of an output with increased pressure.

The air-solution regeneration device (100) includes an air-solution injector (130) which receives the solution, having increased pressure, as input (154) from the solution pump (110). The air-solution injector (130) is an injector which is in venturi type. In other words, the air-solution injector (130) includes a channel having a drive end (131) and a spray end (133). A throat is provided between the drive end (131) and the spray end (133). A suction end (132) is also provided which is opened outwardly from the throat. While the liquid, which enters through the drive end (131), is passing through this throat, the speed and the pressure thereof increase, and vacuum effect occurs at said suction end (132), and the fluid is suctioned from the medium where the suction end (132) exists, and the fluid is mixed from the spray end (133) to the liquid which exists at the drive end (131) and spraying is provided. This is realized thanks to the venturi and coanda effects.

The air-solution regeneration device (100) includes an air-solution separator (150) for providing separation of the air and the solution from each other for the air-solution mixture sprayed from the air-solution injector (130).

An electrostatic filter (140) is provided between the air-solution separator and the air-solution injector (130). The air-solution mixture, which passes through the filter, includes an ionizer (141) as also known in the art for the electrostatic filter (140). The particles, which exist in the solution and in the air, are passed through the high voltage electrical field region. Here, the particles are charged with positive (+) electrical charge. These positively charged particles pass through collection plates arranged in a parallel manner with equal intervals. These plates are negatively and positively charged. While the positively charged plates push these particles, the negatively charged surfaces attract and collect these particles. Thus, the foreign particles which exist in the air are cleaned. The electrostatic filter (140) also includes electro hydrodynamic generator. For this reason, a metal first plate (142) and a metal second plate (143) are provided between the air-solution injector (130) and the air-solution separator. The first plate (142) and the second plate (143) are configured to provide passing of liquid. The solution, which hits the plates, deteriorates the ion balance of the plates and provides formation of voltage between the two plates. Thanks to the voltage formed by the conductor connected between the first plate (142) and the second plate (143), electricity is generated. The generated electricity can be used for the electricity need of the solution pump (110) and the electrostatic filter (140).

The air-solution separator (150) includes an input (154) for entering of the air-solution mixture, a centrifuge unit for providing separation of the air and the solution from each other by means of centrifuge effect, at least one air output opening (152) for exiting of the air separated from the solution, and an output chamber (153) associated with the centrifuge unit (151) for preserving of the solution separated from the air. The vapor pressure of the solution accumulated in the output chamber (153) is equalized to the air vapor pressure by giving vapor to the air or by taking vapor from the air during centrifuge.

The operation of the present invention whose details are described above is as follows:

The air-solution pump draws the solution from the solution chamber (120) and increases the pressure. The solution having increased pressure realizes input (154) through the drive end (131) of the air-solution injector (130), and in this case, air suctioning is realized through the suction end (132) of the air-solution injector (130). The suctioned air and solution is sprayed outwardly through the spray end (133). The sprayed air-solution mixture passes through the electrostatic filter (140). While the mixture passes through the electrostatic filter (140), it is subjected to electrical field and charged, and while the mixture passes through the ionizer (141), the charged particles are caught by the ionizer (141), and when the air-solution mixture, whose ion balance is changed, contacts the first and the second plates (142, 143), electricity is generated. The generated electricity is used for energizing the ionizer and pump, and the automatic operation of the system is provided. The air-solution mixture, which passes through the electrostatic filter (140), passes through spiral channels as a result of the effect of kinetic energy and gravity of the air-solution mixture by the air-solution separator, and the air and the solution are separated from each other as a result of centrifuge. The solution flows to the output chamber (153), and the air exits the air output opening (152) in a cleaned manner.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

What is claimed is:

1. An air-solution regeneration device for providing an equalization of a vapor pressure of a solution to a vapor pressure of an air, wherein the solution exists in the solution chamber, and the air exists in a medium,
wherein the air-solution regeneration device comprises a solution pump for increasing a pressure of the solution;
an air-solution injector, wherein the air-solution injector is in a venturi type and the air-solution injector has a drive end, a suction end, and a spray end, wherein the drive end receives the solution having an increased pressure as input, the suction end is configured for realizing an air suctioning when there is a liquid input having an increased pressure through the drive end, and the spray end is configured to spray the solution received from the drive end and the air suctioned from the suction end;
an electrostatic filter where an air-solution mixture is sprayed; and
an air-solution separator, wherein the air-solution separator has a centrifuge unit for providing a separation of the air-solution mixture received from the input from each other, and an output chamber for collecting the solution, wherein the solution is separated from the air and the solution has been brought to an equal vapor pressure as the air vapor pressure.

2. The air-solution regeneration device according to claim 1, wherein the electrostatic filter comprises a conductive first plate, a conductive second plate, and an ionizer, wherein the conductive first plate allows a liquid passage, the conductive second plate allows the liquid passage, and the ionizer is connected between the conductive first plate and the conductive second plate for providing a separation of charged particles after the sprayed air-solution mixture passes through the conductive first plate and for providing a generation of electricity by forming a voltage difference between the conductive first plate and the conductive second plate when the air-solution mixture contacts the conductive second plate, wherein the air-solution mixture has the charged particles, and the charged particles are separated.

3. The air-solution regeneration device according to claim 1, wherein the air-solution separator comprises an air output opening.
